(19) United States
(12) Patent Application Publication
(10) Pub. No.: US 2026/0306885 A1
(43) Pub. Date: Oct. 8, 2026

(54) DRONE-BASED FIRE PREVENTION, SUPPRESSION AND EVACUATION SYSTEM

(71) Applicant: Maged Kerolos, Camarillo, CA (US)

(72) Inventor: Maged Kerolos, Camarillo, CA (US)

(21) Appl. No.: 19/171,601

(22) Filed: Apr. 7, 2025

(51) Int. Cl. A62C 3/02; B64U 10/60; B64U 50/30; B64U 101/47

(52) U.S. Cl. CPC A62C 3/0242; B64U 10/60; B64U 50/30; B64U 2101/47

(57) ABSTRACT

A drone-based fire prevention, suppression and evacuation system employs multiple firefighting drones strategically placed around the perimeter of a structure. Collectively the firefighting drones spray water or a fire-retardant material on the entire structure and optionally a defined area surrounding the structure. In this way, the drone-based fire prevention, suppression and evacuation system operates as structure-specific firefighting system. In addition, should the need arise, the firefighting drones can be employed to evacuate people and/or cargo from a fire zone.

### BACKGROUND

Preventing structure fires caused by wildfires, as well as quickly spotting and suppressing fires that do break out, is vital to limit damage and save lives. Relying on public firefighting efforts is often not enough. Delayed response times and limited resources makes these efforts less effective at stopping a fire. This is especially true in high wind conditions when firefighting aircraft are grounded, and firefighting efforts are limited to using ground crews.

### SUMMARY

The drone-based fire prevention, suppression and evacuation system implementations described herein generally involve employing multiple firefighting drones strategically placed around the perimeter of a structure. More particularly, in one implementation, the drone-based fire prevention, suppression and evacuation system includes a plurality of electric powered firefighting drones dispersed about a structure. Each drone has one or more nozzles for spraying a portion of the structure that the drone is responsible for spraying with a fire suppressing substance, such as water or a fire-retardant material. In addition, the system includes a plurality of supply hoses for supplying the fire suppressing substance to the plurality of drones. Each supply hose is releasably connected at one end to a different one of the firefighting drones and at the other end to a source of the fire suppressing substance. In addition, each supply hose is long enough for the firefighting drone to which the supply hose is connected to fly about the structure and spray the fire suppressing substance onto the portion of the structure that the drone is responsible for spraying. A plurality of electric power cables is also included to supply electrical power to the plurality of drones. Each power cable is releasably connected at one end to a different one of the firefighting drones and at the other end to a source of electrical power. Each power cable is long enough for the firefighting drone to which the power cable is connected to fly about the structure and spray the fire suppressing substance onto the portion of the structure that the drone is responsible for spraying.

In another implementation, the drone-based fire prevention, suppression and evacuation system includes a plurality of electric powered drones, each including batteries for powering the drone, one or more cameras, a GPS system, a two-way communication system, and a computing device that receives inputs from and controls the drone including the camera or cameras, GPS system and the communication system. An evacuation unit is also included. The evacuation unit is a structure with securing devices for securing one or more people, or cargo, or both in the evacuation unit. An attachment apparatus automatically attaches one or more of the drones to an evacuation unit. Whenever the computing device of a firefighting drone receives an evacuation command, the computing device confirms the evacuation command was transmitted by a person authorized to order the drone to evacuate one or more persons, or cargo, or both in the evacuation unit. If confirmed, the computing device flies the drone to a prescribed storage area where the evacuation unit is located, attaches the evacuation unit to the drone using the attachment apparatus, flies the drone with the evacuation unit attached to a prescribed evacuation site for loading of one or more persons, or cargo, or both into the evacuation unit if the evacuation site is not at the storage area, and after the loading of one or more persons, or cargo, or both into the evacuation unit is complete, flies the drone with the loaded evacuation unit attached to prescribed safe location.

In yet another implementation, the drone-based fire prevention, suppression and evacuation system includes a plurality of docking stations, each of which is employed to house and protect a different one of the firefighting drones whenever the drone is not in use.

The foregoing Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more detailed description that is presented below.

### DESCRIPTION OF THE DRAWINGS

The specific features, aspects, and advantages of the drone-based fire prevention, suppression and evacuation system implementations described herein will become better understood with regard to the following description, appended claims, and accompanying drawings where:

FIGS. 1A-B are diagrams illustrating exemplary implementations of a fire prevention, suppression and evacuation system that employs multiple firefighting drones which are placed around the perimeter of a structure.

FIGS. 2A-B are diagrams illustrating, in simplified form, one implementation of the firefighting drone employed in the fire prevention, suppression and evacuation system. FIG. 2A is a side view, and FIG. 2B is a top view, of the firefighting drone.

FIG. 3 is a partially cutaway diagram illustrating an exemplary implementation of a docking station that surrounds the firefighting drone and protects it from the outside environment when the drone is docked in the station.

FIG. 4 is a diagram illustrating one implementation, in simplified form, of a firefighting drone computing device, various input and output data signals, and various computer programs running on the firefighting drone computing device.

FIG. 5 is a diagram illustrating one implementation, in simplified form, of a water tank installation apparatus that attaches a pre-filled water tank to the firefighting drone and connects the drone's water supply line input to a water output of the tank.

FIG. 6 is a diagram illustrating one implementation, in simplified form, of a water tank that attaches to the firefighting drone, and which includes a pump and refill hose.

FIG. 7 is a diagram illustrating another implementation, in simplified form, of a water tank that attaches to the firefighting drone, and which includes a pump and openable and closeable ports.

FIG. 8 is a diagram illustrating yet another implementation, in simplified form, of a water tank that attaches to the firefighting drone, and which includes openable and closeable ports.

FIG. 9 is a diagram illustrating one implementation, in simplified form, of an evacuation unit having a platform with a cage-like structure, as well as attachment devices that are capable of automatically connecting to the firefighting drone, and provisions for safely carrying one or more people and/or cargo.

FIG. 10 is a diagram illustrating one implementation, in simplified form, of interconnecting drones that includes two or more firefighting drones that are interconnected and configured to fly as a single entity, where each of the drones resides within, and is attached to a frame that surrounds the drone.

FIG. 11 is a diagram illustrating an implementation, in simplified form, of an interconnecting firefighting drone with the firefighting drone centered within a square frame and connected to the frame with struts.

FIG. 12 is a diagram illustrating an implementation, in simplified form, of an interconnecting firefighting drone with a square frame and protective mesh installed.

FIG. 13 is a diagram illustrating an implementation, in simplified form, of the interconnection hardware attached to the frame of a pair of interconnecting firefighting drones.

FIG. 14 is a diagram illustrating an implementation, in simplified form, of an extra battery pack and an electronics package attached to the inside of a structural component of the frame employed in an interconnecting firefighting drone.

### DETAILED DESCRIPTION

In the following description of the drone-based fire prevention, suppression and evacuation system implementations reference is made to the accompanying drawings which form a part hereof, and in which are shown, by way of illustration, specific implementations in which the system can be practiced. It is understood that other implementations can be utilized, and structural changes can be made without departing from the scope of the drone-based fire prevention, suppression and evacuation system.

It is also noted that for the sake of clarity specific terminology will be resorted to in describing the drone-based fire prevention, suppression and evacuation system implementations and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation” means that a particular feature, a particular structure, or particular characteristics described in connection with the implementation or implementation can be included in at least one implementation of the drone-based fire prevention, suppression and evacuation system. The appearances of the phrases “in one implementation”, “in another implementation”, “in an exemplary implementation”, “in an alternate implementation”, “in one implementation”, “in another implementation”, “in an exemplary implementation”, and “in an alternate implementation” in various places in the specification are not necessarily all referring to the same implementation or implementations, nor are separate or alternative implementations/implementations mutually exclusive of other implementations/implementations. Yet furthermore, the order of process flow representing one or more implementations or implementations of the drone-based fire prevention, suppression and evacuation system does not inherently indicate any particular order nor imply any limitations of the system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

### 1.0 Drone-Based Fire Prevention, Suppression and Evacuation System

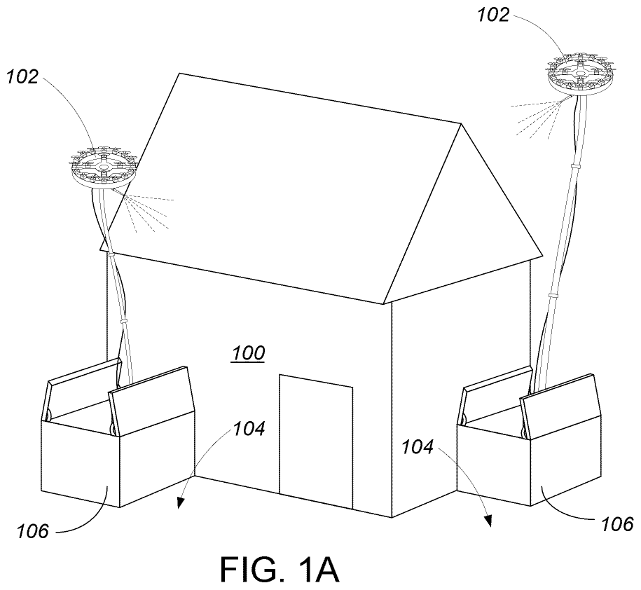

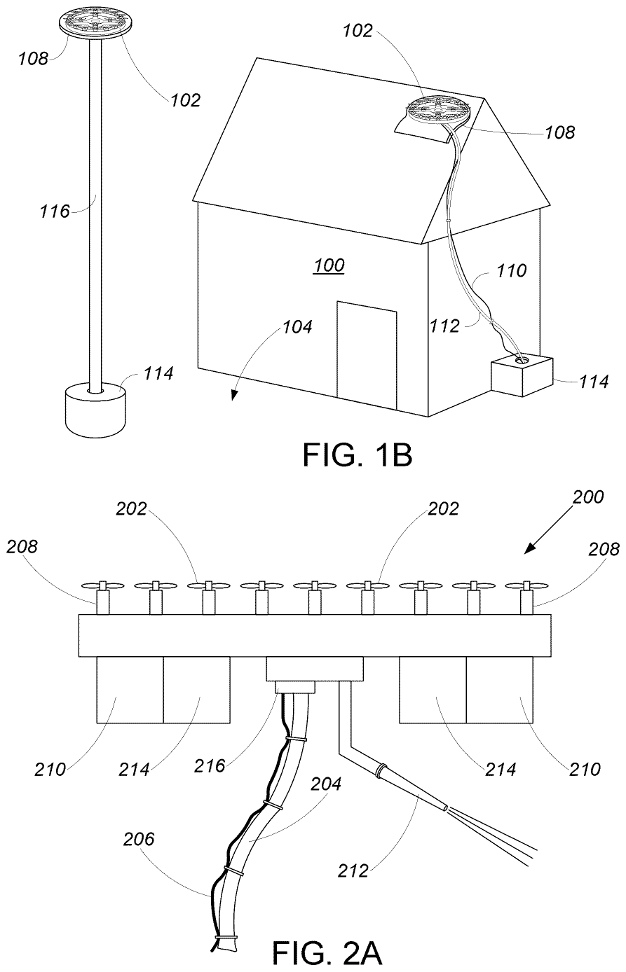

In one implementation as illustrated in FIGS. 1A-B, the fire prevention, suppression and evacuation system involves employing multiple firefighting drones 102 strategically placed around the perimeter of a structure 100. These firefighting drones 102 are docked on the roof of the structure 100, or on the outer walls of the structure between the roof and the ground (not shown), or on the ground adjacent the base of the structure, or on top of a pole located adjacent the structure. For example, in FIG. 1A, two firefighting drones 102 are depicted in operation, namely spraying water on the structure 100. The two drones shown in FIG. 1A are docked on the ground adjacent the base of the structure 100. In this exemplary implementation, the firefighting drones 102 are housed in a docking station 106, which will be described in more detail in a section to follow. FIG. 1B shows two firefighting drones 102 depicted in their docked position. One of the firefighting drones 102 (shown on the right) is docked on a mounting structure 108 on top of the roof of the structure 100. In this example, the drone's water supply hose 110 and electrical power cable 112 is stored in a box 114 on the ground adjacent the structure where they are connected to a pressurized water supply and the structure's electrical power, respectively. In an alternate implementation not shown in FIGS. 1A-B, a firefighting drone's water supply hose and electrical power cable are wound around a hose reel that plays them out when the drone is in operation. In this alternate implementation, the water supply hose and electrical power cable are connected to a pressurized water supply and the structure's electrical power, respectively, coming from the structure. It is noted that the box 114 or the hose reel (not shown) can be located on the roof of the structure, or on the outer walls of the structure between the roof and the ground (not shown), or on the ground adjacent the base of the structure. The other firefighting drone 102 (shown on the left) is docked on a mounting structure 108 located on top of a pole 116. In this example, the drone's water supply hose and electrical power cable are stored in a box 114 located at the bottom of the pole 116 where they are connected to a pressurized water supply and the structure's electrical power, respectively. It is noted that in the example involving the pole 116, although it cannot be seen in FIG. 1B, the firefighting drone's water supply hose and electrical power cable are routed up through a hollow interior of the pole from the box 114 at the bottom of the pole to the drone 102. In an alternate implementation (not shown), the drone's water supply hose and electrical power cable are routed from the box to the firefighting drone outside the pole 116. Although two firefighting drones 102 are depicted in FIGS. 1A and 1B, the actual number of firefighting drones employed and their distribution around the structure 100 is chosen such that they collectively are able to spray water on the entire structure and optionally a defined area 104 surrounding the structure. In this way, the drone-based fire prevention, suppression and evacuation system operates as a structure-specific firefighting system that is not reliant on public firefighting resources.

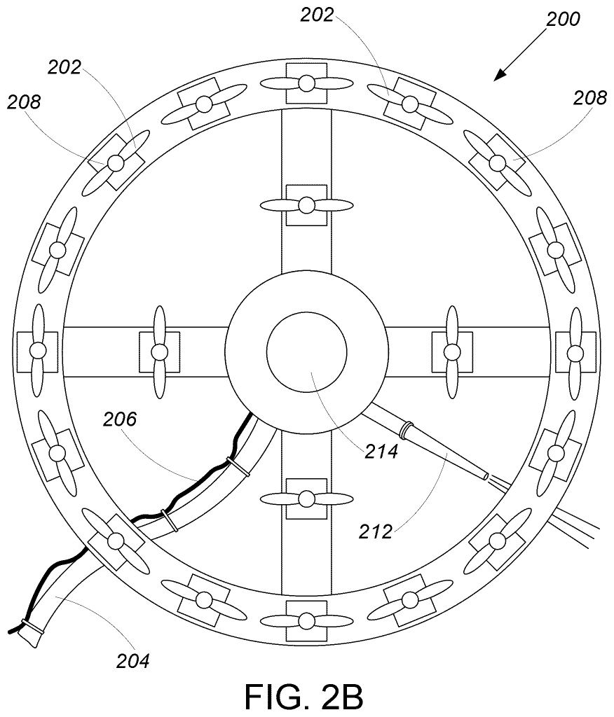

In one implementation, as illustrated in FIGS. 2A and 2B, the firefighting drone 200 is a multi-rotor drone with enough horizontally oriented rotors 202 to lift the drone, a water supply hose full of water 204, an electrical power cable 206 and other equipment to be described in sections to follow. The firefighting drone 200 also should exhibit excellent maneuverability during flight. It can move up or down, side to side, and rotate. The firefighting drone 200 employs separate electric motors 208 to power each rotor 202. These electric motors 208 are powered via the aforementioned power cable 206 or using on-board rechargeable batteries 210. The firefighting drone 200 should also be capable of carrying cargo. For example, one commercially available drone that could be employed (with modification) is the drone manufactured by Aerones Engineering of Lake Dallas, TX. This drone has 28 electric motors with rotors, 16 rechargeable batteries, a nozzle spraying system fed by a water supply hose connected to the drone that can spray water at a rate of 100 liters per minute, and is powered by an electric power cable connected to drone. This drone is capable of lifting 400 pounds, and its batteries, when fully charged, can provide a 20-minute fight time assuming the power cable is not providing power.

Each of the firefighting drones 200 includes one or more spray nozzles 212 that are capable of spraying water in one or multiple directions. In one implementation, the nozzles 212 are fixed and spray water in a pre-determined direction, and in another implementation, the nozzles are pointable and the direction the water is sprayed can be changed. In either case, water is sprayed from the nozzle(s) onto the structure (and optionally the surrounding property) based on a prescribed pattern, or on-the-fly based on instructions received by the firefighting drone, or as determined by an on-board computing device. In the fixed nozzle configuration, the foregoing spray directionality is achieved by maneuvering the firefighting drone. In the pointable nozzle configuration, the spray directionality is achieved by maneuvering the firefighting drone, or pointing the nozzle(s), or both.

In one implementation, each firefighting drone 200 is connected to a pressurized water source (not shown) via the water supply hose 204. The connection to the pressurized water source can be done via a new or existing tap of the structure's pressurized water system and can be made near a docking area of the firefighting drone or anywhere on, in, or near the structure. The water supply hose 204 has a cross-sectional area that is capable of delivering a prescribed volume of water to the nozzle(s) 212. The prescribed maximum volume of water delivered per unit of time (e.g., gallons per minute), as well as the length of the hose 204, is chosen to optimize the fire prevention and suppression duties of the firefighting drone 200. In addition, the firefighting drone 200 employed is chosen to be capable of lifting the water supply hose 204 to the height necessary for the fire prevention or suppression task when it is full of water, as well as other on-board equipment that will be described in sections to follow.

In one implementation, each of the firefighting drones 200 is also connected to a power source (not shown) via an electrical power cable 206. The power source and power cable 206 are chosen so as to provide the amount of continuous power that the firefighting drone requires to perform its fire prevention and suppression duties. As such, as long as the firefighting drone 200 is connected to the power source, and the power source is providing power, the firefighting drones have an unlimited flight time.

However, in another implementation, each of the firefighting drones also includes batteries 210 for powering the drone when power from the power source is not available. This battery back-up feature is advantageous in many circumstances, including when a firefighting drone 200 is called upon to detach itself from the power source (as will be described in sections to follow), or where the power source is not providing power (e.g., due to damage or a power outage). It is noted that when power is being supplied to the firefighting drones from the power source, the power is used to both operate the drone and to keep the batteries fully charged.

### 1.1 Docking Station

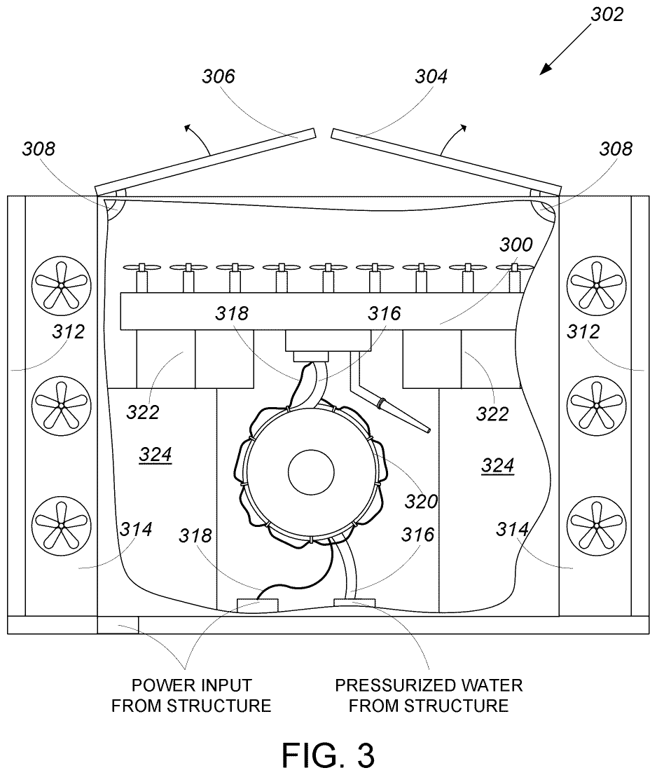

In one implementation, illustrated in FIG. 3, each firefighting drone 300 is housed in a docking station 302. The docking station 302 primarily surrounds the firefighting drone 300 and protects it from the outside environment when the drone is not in operation. To this end, when the firefighting drone 300 is activated, the docking station 302 opens to let the drone out. In the implementation depicted in FIG. 3, the top of the docking station 302 is split at its midline into two panels 304, 306 and opens by having motors 308 rotate the panels upward. In one version, the motors 308 that rotate the panels 304, 306 are controlled wirelessly by the firefighting drone's computing device (which will be described in sections to follow).

The docking station 302 can provide additional useful and advantageous features as well. For example, the water supply hose 316 and electrical cable 318 that respectively provide water and electrical power to the firefighting drone 300 are long enough to allow the drone to leave the docking station and spray water on at least a portion of the structure (and optionally at least a portion of the area surrounding the structure). In one version, the water hose 316 and electrical cable 318 are bound together and wound around a reel 320. The reel 320 plays out the hose 316 and cable 318 as needed when the firefighting drone 300 is operational and retracts the hose and cable when the firefighting drone returns to the docking station 302. The reel 320 can be located inside the docking station 302 (as shown in FIG. 3) or attached to the exterior of the station (not shown).

As mentioned previously, in one implementation, the firefighting drones include batteries for powering the drone. In one version shown in FIG. 3, the batteries 322 are detachable, and the docking station 302 includes an apparatus 324 for installing the batteries onto the firefighting drone. Further, the battery installation apparatus 324 can include extra batteries so that a firefighting drone that is operating on batteries alone (e.g., when the power cable is not attached) can exchange depleted batteries for fresh ones should the need arise. The battery installation apparatus 324 has the capability to charge depleted batteries as well.

To power the motors 308 used to open the docking station panels 304, 306, as well as powering the reel 320 and battery installation apparatus 324, the docking station 302 is also supplied with electrical power. In one version, the docking station 302 connects to the structure's power (as does the electrical power cable 318 connected to the firefighting drone 300). In an alternate version, in addition to or instead of being connected to the structure's power, the docking station 302 can include its own electric power generating source, such as a solar 312 and/or wind powered 314 generator. The docking station's electric power generating source would provide enough power to operate the docking station systems and keep the batteries fully charged. This is particularly advantageous in a situation where the structure's power is turned off for an extended period of time as a precaution, such as when power is shut off to an area when the danger of a wildfire is high. In such a situation, the solar and/or wind powered generator can keep the drone-based fire prevention, suppression and evacuation system operational, albeit the firefighting drones would be running on batteries only.

### 1.2 Fire Prevention Mode

Referring again to FIG. 2A, in one implementation, each of the firefighting drones 200 includes one or more cameras, a GPS system, and a two-way communication system with an internet connection bundled in one or more electronics packages 214 attached to the drone. The aforementioned computing device that controls the firefighting drone 200 is also included in one of the electronics packages 214. In one version, the two-way communication system is also capable of monitoring fire, police and public safety radio communications. The two-way communication system can employ a wireless (e.g., wifi) connection to the structures network. In addition to, or in lieu of, the structure's network, the two-way communication system can employ a cellular communications network connection. Further, in addition to, or in lieu of, the structure's network and/or the cellular communications network connection, the two-way communication system can employ a satellite communications network. Having an alternate communications connection via cellular and/or satellite, rather than just relying on the structures network, is advantageous should the structure's network (or even cellular communication) be disrupted in a fire emergency.

It is noted that the previously described docking station (302 in FIG. 3) includes one or more walls that are visually transparent so that the firefighting drone's cameras can capture images while the drone is still in its station. In addition, the walls of the docking station are made of materials that are substantially transparent to wifi, cellular and satellite communication signals so that the firefighting drone's communication system(s) can receive and send signals while the drone is still in its station.

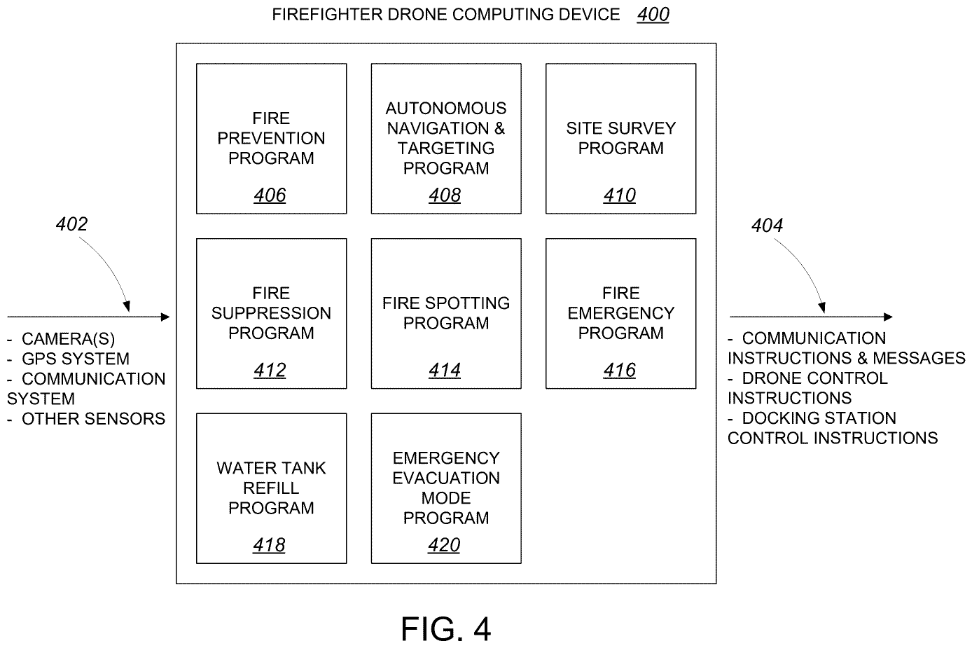

Referring now to FIG. 4, the firefighting drone's computing device 400 receives inputs 402 from the camera or cameras, GPS system, the communication system, and any other sensors on-board the drone. In addition, the firefighting drone's computing device 400 outputs 404 messages and instructions to control the firefighting drone, docking station (if employed), as well as the camera or cameras, GPS system, the communication system, and any other sensors on-board the drone. The computing device 400 can also output 404 instructions to the communication system to monitor specified internet sites and radio communications, as well as send messages via the communication system.

In one implementation, the cameras and internet connection are used to determine if the fire prevention task should be initiated. More particularly, the internet connection is used by computing device's fire prevention program 406 to monitor local weather conditions and alerts indicative of a fire danger in the area of the structure. The fire prevention program 406 is programmed to use the fire danger intelligence gathered from the internet to initiate a fire prevention mode if warranted. The camera(s) and GPS system are then used by the fire prevention program 406 to implement a fire prevention action plan. The plan involves the computing device using any appropriate existing autonomous navigation and targeting programs 408 to cause the firefighting drones to spray water on the structure and optionally on the surrounding area in order to make them less susceptible to catching fire should embers from a fire reach the structure. Wet structures and watered vegetation do not catch fire as readily as dry surfaces and vegetation. This fire prevention process can be repeated periodically as long as the fire danger persists. For example, in Southern California, if a fire weather danger condition exists (i.e., low humidity and high winds), the fire prevention process can be repeated periodically until the danger subsides (which can be several days).

In one implementation, the fire prevention program 406 is pre-programmed with fire threat assessment information specific to the structure being protected. Such fire threat assessment information is available from publicly available fire safety site surveys. For example, if it is known that the structure being protected is in a high fire danger zone, the preventive spraying can be more frequent than if the structure is in a moderate or low fire danger zone. Alternately, the firefighting drones can be used to perform a site survey using their on-board camera(s) and access to fire safety information available on the internet (including publicly available fire safety site surveys) via their communication connection to generate the fire threat assessment information specific to the structure being protected. For example, historical wildfire data and topographical data can be obtained via the internet. This data may indicate the structure is in an area historically prone to high winds and past wildfires. The firefighting drones would fly without spraying water to capture the local site survey information. Any appropriate existing site survey software program 410 can be run on the firefighting drones computing device to recognize specific local fire hazards applicable to the structure being protected and its surrounding area from the camera images captured during the local site survey. In this way, local fire hazards not typically found in publicly available site surveys, or recently created hazards, can be identified. For example, the presence of propane tanks near the structure or overgrown vegetation might be discovered in a local site survey and then considered in implementing the fire protection action plan. As such, the fire protection action plan is tailored to the structure being protected. This may entail increasing the amount of water and the frequency of spraying in areas identified as high fire threats in the fire threat assessment. In addition, the firefighting drones can employ their two-way communication capability to send a message (e.g., via text or email) to the person responsible for the structure's fire safety measures that potential fire hazards were discovered in the fire threat assessment and suggesting mitigating action be taken (e.g., clearing overgrown vegetation).

In one implementation, the computing devices of each drone are in communication with each other. In the case of the fire prevention mode, this intercommunication between the firefighting drones allows information (e.g., camera images) to be shared and a joint fire prevention action plan can be formulated for all the drones. This joint fire protection action plan assigns a portion of the structure (and optionally a portion of the area surrounding the structure) that is to be sprayed with water to each firefighting drone.

### 1.3 Fire Suppression Mode

Referring again to FIG. 4, in one implementation, the previously described cameras and internet connection are used in the fire suppression task executed by a fire suppression program 412 running on the firefighting drone's computing device. Whenever information is received either via the camera(s) or via the internet that a fire may imminently threaten the structure being protected, the firefighting drone's computing device switches to a fire suppression mode. In implementations where the firefighting drones are in communication with each other, whenever one of the drone's computing device switches to fire suppression mode, all the other drones switch as well.

The fire suppression mode generally entails the firefighting drones continuously spraying water on the structure and its surrounding area in accordance with a prescribed fire suppression action plan. In implementations where the firefighting drones that are in communication with each other, the fire suppression action plan is a joint plan that assigns a portion of the structure (and optionally a portion of the area surrounding the structure) that is to be sprayed with water to each firefighting drone.

In addition to each firefighting drone's computing device monitoring weather and fire alerts via the drone's communication system to identify fires that may imminently threaten the structure being protected, the output from the camera(s) can also be employed by an appropriate existing fire-spotting software program 414 running on a firefighting drone's computing device to spot signs of a fire on the structure or in the area surrounding the structure. To this end, the camera(s) include both visual spectrum and infrared imaging capability. For example, windblown wildfires can carry burning embers and other debris over long distances. This can cause spot fires to ignite wherever the burning embers and debris land. The fire-spotting software program 414 running on the firefighting drone's computing device uses the camera output to locate these spot fires, and the drone or drones that can reach the spot fire with their spray are directed to extinguish the blaze. Once the spot fire is extinguished, the firefighting drones involved return to their continuous spraying task.

It is noted that the drone-based fire prevention, suppression and evacuation system implementations described herein are not limited to responding to only external fires. Rather, in one implementation, each firefighting drone's computing device can be in communication with the structure's fire alarm system. If the firefighting drone(s) receives an alert that there is an internal structure fire, the firefighting drone(s) switches to the fire suppression mode and begins fire suppression operation as described previously.

### 1.4 Fire Emergency Mode

A variety of circumstances typically encountered in a fire can trigger the fire emergency mode. For example, the firefighting drone or drones tasked to spray a spot fire on the structure or in the surrounding area may not be able to extinguish the fire without the help of other firefighting drones in the system whose spray could not reach the spot fire. In another implementation, a fire emergency mode is triggered if the structure's electric power fails when the drone-based fire protection and suppression system is in fire suppression mode, and only backup power measures (e.g., extra batteries and solar and/or wind powered generators) are available. In yet another implementation, a fire emergency mode is triggered if the pressurized water supply from the structure is lost when the drone-based fire protection and suppression system is in fire suppression mode. It is noted that implementations of the drone-based fire prevention, suppression and evacuation system that are capable of invoking the fire emergency mode are versions where the firefighting drones have on-board batteries.

In operation, referring again to FIG. 4, if a fire emergency program 416 running on the firefighting drone's computing device detects a condition such as one of those just described via its camera(s), communication system, and other sensors, it switches to the fire emergency mode. In one implementation, the fire emergency mode involves a firefighting drone's computing device instructing the firefighting drone to disconnect from the water supply hose and electrical cable. To this end, the water supply hose and electrical cable are attached to the firefighting drones by connectors that include a detachment apparatus (216 in FIG. 2A). The detachment apparatus detaches the water supply hose and electrical cable when instructed to do so by the firefighting drone's computing device.

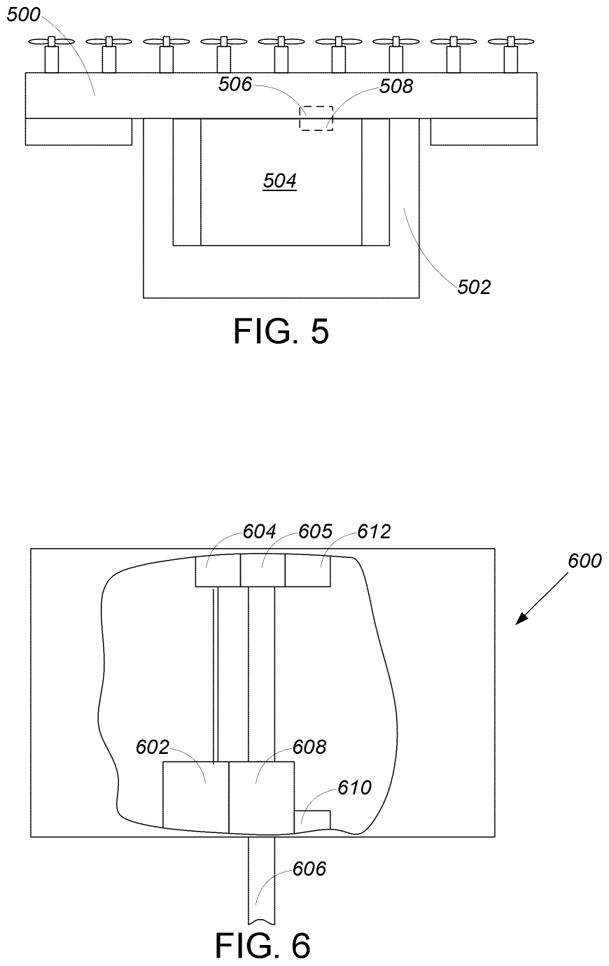

Once a firefighting drone is detached from its water supply hose and electrical cable, it is in free-flight mode. The firefighting drone in free-flight mode must first obtain a supply of water to continue spraying the structure (and optionally the area surrounding the structure). In one implementation depicted in FIG. 5, this involves the firefighting drone 500 flying to a water tank storage area located near the structure being protected. In this implementation, the water tank storage area includes a water tank installation apparatus 502 that attaches a pre-filled water tank 504 to the firefighting drone 500 and connects the drone's water supply line input 506 to a water output of the tank 508. In one version shown in FIG. 6, the water tank 600 includes a pump 602 that pumps the water in the tank to the previously described nozzle(s) of the firefighting drone at a rate that creates the desired pressure and flow rate from the nozzle(s). In this version, the water tank attachment process includes connecting a power outlet of the firefighting drone to an electrical connector 604 on the tank 600, as well as connecting the drone's water supply line input to a water output of the tank 605. The electrical connector 604 is wired to the pump 602 and brings drone battery power to the pump. It is noted that while not shown, in an alternate implementation the water tank can include its own batteries to operate the pump. Once the water tank 600 is attached to the firefighting drone, a pump valve 608 is then configured to route water from the interior of the water tank 600 to the firefighting drone and the drone returns to the structure. When the firefighting drone arrives back at the structure, the pump 602 is engaged to continue spraying water on the structure (and optionally the area surrounding the structure). Additionally, in one version, the water tank 600 includes a refill hose 606 that hangs down from the water tank 600, and which is connected to the pump valve 608 that either sends water pumped from inside the water tank by the pump 602 to the firefighting drone (and eventually to the drone's nozzle(s)) or sends water drawn up through the refill hose 606 from an open water source by the pump into the interior of the water tank 600. The pump valve 608 and the pump 602 are wirelessly controlled by the firefighting drone's computing device that runs a water tank refill program (418 in FIG. 4). In operation, the water tank refill program causes the firefighting drone to monitor a refill sensor 610 that senses when the water tank 600 is empty. When the water tank 600 is empty, the refill sensor 610 (which can be powered by its own battery) wirelessly sends a signal to the firefighting drone's computing device via the drone's communication system indicating that the tank is empty. The water tank refill program causes the firefighting drone to fly to a known local open water source (such as a swimming pool, pond, stream, lake, reservoir, the ocean, and so on) and to lower the distal end of the refill hose 606 into the source. The pump valve 608 is then configured to route water from the source to the interior of the water tank 600, and the pump 602 is engaged. A second refill sensor 612 senses when the water tank 600 is full. When the water tank 600 is full, the second refill sensor 612 (which can be powered by its own battery) wirelessly sends a signal to the firefighting drone's computing device via the drone's communication system indicating that the tank is full. The pump valve 608 is then configured to route water from the interior of the water tank 600 to the firefighting drone and the drone returns to the structure. Once the firefighting drone has arrived back at the structure, the pump 602 is engaged to continue spraying water on the structure (and optionally the area surrounding the structure).

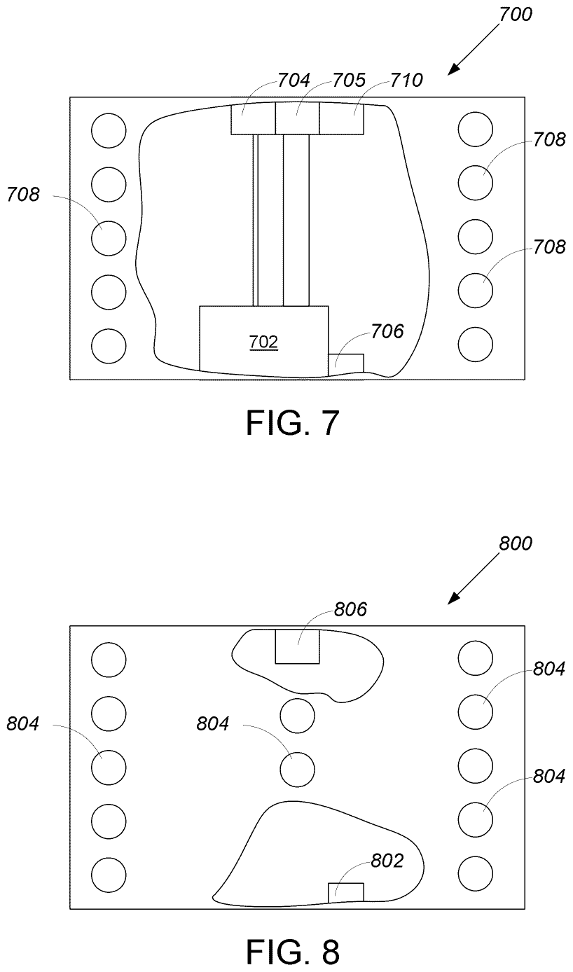

Referring to FIG. 7, an alternate version of the water tank 700 includes a pump 702 that pumps the water in the tank to the previously described nozzle(s) of the firefighting drone at a rate that creates the desired pressure and flow rate from the nozzle(s). In this version, the water tank attachment process includes connecting a power outlet of the firefighting drone to an electrical connector 704 on the tank 700, as well as connecting the drone's water supply line input to a water output of the tank 705. The electrical connector 704 is wired to the pump 702 and brings drone battery power to the pump. The pump 702 is wirelessly controlled by the firefighting drone's computing device. It is noted that while not shown, in an alternate implementation the water tank can include its own batteries to operate the pump instead. Once the water tank 700 is attached to the firefighting drone it returns to the structure, and pump 702 is engaged to continue spraying water on the structure (and optionally the area surrounding the structure). The firefighting drone's computing device also runs a water tank refill program (418 in FIG. 4). In operation, the water tank refill program causes the firefighting drone to monitor a refill sensor 706 that senses when the water tank 700 is empty. To this end, the refill sensor 706 (which can be powered by its own battery) wirelessly sends a signal to the firefighting drone's computing device via the drone's communication system indicating that the tank is empty. The water tank refill program then causes the firefighting drone to fly to a known local open water source (such as a swimming pool, pond, stream, lake, reservoir, the ocean, and so on) and to lower the water tank into the source. Openable and closeable ports 708 located in various locations on the outer walls of the water tank 700 are opened to allow water from the water source to flow into the water tank. The ports 708 can be located on all or just some of the walls of the water tank 700, including its top and bottom. In FIGS. 7, 10 round ports 708 are depicted on one side of the water tank 700. However, the number and shape of the ports can vary as long as they allow the water tank to quickly fill when lowered into the source. Any appropriate opening and closing mechanism can be employed to open and close the ports. A second refill sensor 710 senses when the water tank 700 is full. When the water tank 700 is full, the second refill sensor 710 (which can be powered by its own battery) wirelessly sends a signal to the firefighting drone's computing device via the drone's communication system indicating that the tank is full, and the firefighting drone returns to the structure. Once the firefighting drone has arrived back at the structure, the pump 702 is engaged to pump water from inside the water tank 700 to the drone (and eventually to the drone's nozzle(s)) to continue spraying water on the structure and optionally the area surrounding the structure.

Referring to FIG. 8, another alternate version of the water tank 800 eliminates the pump and electrical/water connections to the firefighting drone. In this version, once the water tank 800 is attached to the firefighting drone it returns to the structure, and the computing device opens water tank ports 804 to drop water on the structure (and optionally the area surrounding the structure). The firefighting drone's computing device also runs a water tank refill program (418 in FIG. 4). In this version, the water tank refill program causes the firefighting drone to monitor a refill sensor 802 that senses when the water tank 800 is empty. To this end, the refill sensor 802 (which can be powered by its own battery) wirelessly sends a signal to the firefighting drone's computing device via the drone's communication system that the tank is empty. When the water tank 800 is empty, the water tank refill program causes the firefighting drone to fly to a known local open water source (such as a swimming pool, pond, stream, lake, reservoir, the ocean, and so on) and to lower the water tank into the source. Openable and closeable ports 804 located in various locations on the outer walls of the water tank 800 are opened to allow water from the water source to flow into the water tank. The ports 804 can be located on all or just some of the walls of the water tank 800, including its top and bottom. In FIGS. 8, 12 round ports 804 are depicted on one side of the water tank 800. However, the number and shape of the ports can vary as long as they allow the water tank to quickly fill when lower into the source. Any appropriate opening and closing mechanism can be employed to open and close the ports. A second refill sensor 806 senses when the water tank 800 is full. When the water tank 800 is full, the second refill sensor 806 (which can be powered by its own battery) wirelessly sends a signal to the firefighting drone's computing device via the drone's communication system indicating that the tank is full and the ports 804 are closed. The firefighting drone then returns to the structure. Once the firefighting drone has arrived back at the structure, the computing device opens the water tank ports 804 to drop water on the structure (and optionally the area surrounding the structure).

If the drone-based fire prevention, suppression and evacuation system implementation being used is one having detachable batteries and a docking station apparatus for installing replacement batteries onto the firefighting drone, the drone can return to the docking station to be retrofitted with fully charged replacement batteries when its onboard batteries are running low on power. However, unless the docking station has been configured to allow the firefighting drone to have its batteries replaced while the water tank is attached, the water tank would have to be removed first and reattached afterwards.

### 1.5 Emergency Evacuation Mode

The emergency evacuation mode is an overriding mode that can be invoked when the drone-based fire prevention, suppression and evacuation system is in any other mode. This includes the fire prevention mode, fire suppression mode, fire emergency mode, or an inactive mode when the system is not operating. The emergency evacuation mode is initiated by a communication (via any of the previously described communication avenues) from an authorized person to an emergency evacuation mode program (420 in FIG. 4) running on the firefighting drone's computing device. The authorized person can be the person responsible for maintaining the drone-based fire prevention, suppression and evacuation system for the structure being protected, or the owner of the structure, or local authorities (e.g., fire department, police department, among others), or any combination of these people. In one version, the emergency evacuation mode would be initiated by the authorized person submitting a pre-set code to the firefighting drone. It is noted that when there are multiple firefighting drones in the system and they are in communication with each other, various options are available. Namely, the firefighting drones can be placed in the emergency evacuation mode individually. In this version, the firefighting drones not placed in the emergency evacuation mode would continue to operate in whatever mode they are currently executing. Alternately, when one of the firefighting drones is put into the emergency evacuation mode, all the drones can be automatically placed in the emergency evacuation mode. It is noted that the emergency evacuation mode is only applicable to the system implementations that include firefighting drones with batteries.

In one implementation, the emergency evacuation mode involves the emergency evacuation mode program (420 in FIG. 4) first receiving the initiating message and confirming it is from an authorized person. Next, the charge status of the firefighting drone's batteries is assessed. If the firefighting drone's batteries have a charge status below a prescribed minimum, the drone returns to the docking station if not already there and its batteries are replaced with fully charged batteries. It is noted that if the system implementation does not include the capability to change out batteries on the firefighting drones, then the drone's computing device reports back to the person initiating the emergency evacuation mode that the drone is not available. However, if the firefighting drone's batteries have a charge status above the prescribed minimum (or the drone has obtained fully charged replacement batteries), then the drone's computing device disconnects the water supply hose and electric power cable from the drone, if they are still connected. In addition, if the firefighting drone has a water tank attached, it is jettisoned.

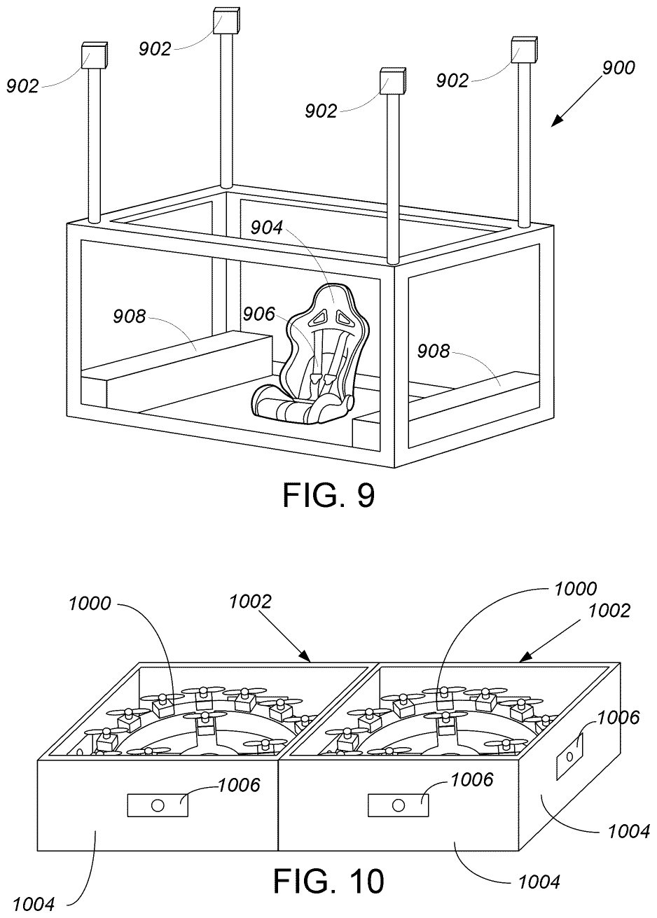

The emergency evacuation mode program next causes the firefighting drone to fly to a prescribed storage area on or near the structure which houses a drone-attachable evacuation unit. Referring to FIG. 9, in one implementation, the evacuation unit is a platform with a cage-like structure having provisions for safely carrying one or more people (e.g., seats 904, safety harnesses 906, and so on). The evacuation unit 900 also includes attachment devices 902 that are capable of automatically connecting to the firefighting drone. Once the firefighting drone arrives at the storage area it aligns itself with the evacuation unit's attachment devices 902 and connects to the unit 900. The firefighting drone then waits at the storage area for instructions from an authorized person to airlift the evacuation unit to a safe location. For example, the firefighting drone can use its GPS system, and the drone's computing device can use an appropriate existing autonomous navigation software program (408 in FIG. 4) to navigate. The authorized person sends GPS coordinates for the safe location. In one scenario, a passenger or passengers get onto the evacuation unit, and/or cargo is loaded onto evacuation unit, and secured. The firefighting drone's batteries may have sufficient charge to carry the evacuation unit with its passenger(s) and/or cargo to a safe location. However, in one version, the evacuation unit 900 would be equipped with additional charged batteries 908 that would connect to the firefighting drones power system via a power coupling that is part of the aforementioned attachment devices 902. The extra battery power is provided to ensure the loaded evacuation unit has enough power to make it to the safe location. If the evacuation unit is equipped with batteries, it may be possible to skip the previously described action of replacing the batteries before attaching the evacuation unit. In one variation, rather than waiting in the storage area to be loaded, the firefighting drone with the evacuation unit attached can fly to a predetermined loading zone for loading the passenger(s) and/or cargo before flying to the safe location.

### 1.5.1 Interconnecting Drone System

If the weight of the people and/or cargo is too much for a single drone to carry to safety, but can still fit in the evacuation unit, then an interconnecting drone system can be employed. A general implementation of the interconnecting drone system includes two or more firefighting drones that are interconnected and configured to fly as a single entity. In one implementation shown in FIG. 10, each firefighting drone 1000 is modified to include a frame 1002 that surrounds the drone.

In the implementation of FIG. 10, the frame 1002 of the firefighting drone 1000 has a square structure. The square frame structure 1002 is constructed from four rectangular bars 1004. The ends of the bars 1004 are connected together via any appropriate method, such as by bolting, welding, gluing, molding the components together as one piece, and so on. In addition, at least two of the sides of the frame 1002 include interconnection hardware 1006 that is used to connect a side of the frame to a side of the frame of another firefighting drone, thereby connecting two firefighting drones together. In general, the square frame is oriented so that its “midline” plane is generally perpendicular to the central vertical axis of the firefighting drone and resides at a height that is closest to the “mid-height” of the drone. The square frame is centered horizontally on the drone such that a vertical axis through its centroid is substantially coincident with the central vertical axis of the drone. The horizontal width of the square frame is such that it extends past the footprint of the drone an equal distance from each side by a prescribed distance (e.g., 2-3 inches). In one version, there is interconnection hardware located just in the middle of the frame side (as shown in FIG. 10), or in another version there are two separate interconnection hardware assemblies at each end of the frame side, or in yet another version, the frame side could have interconnection hardware assemblies at each end and in the middle. Each side of a square frame can also include one or more battery packs and an electronics package, as will be described in more detail in sections to follow. In addition, any number of additional firefighting drones can be added in any desired pattern. For example, a 2 by 2 matrix could be formed from 4 firefighting drones. At any place where two sides of the frames of adjacent firefighting drones touch each other in the matrix, they are connected together using their respective interconnection hardware.

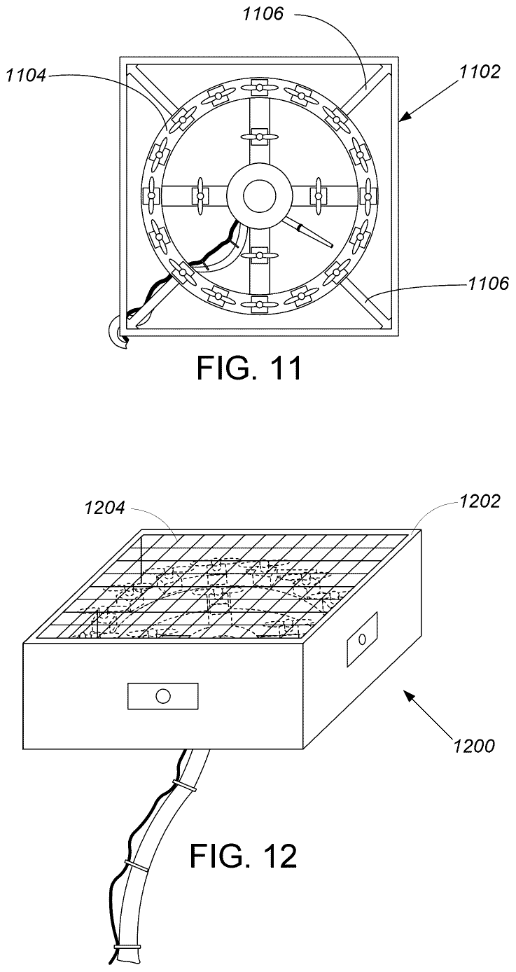

In one version shown in FIG. 11, the square frame 1102 is connected to the firefighting drone 1104 via struts 1106. Each of the struts 1106 is securely attached (via appropriate fasteners) at a proximal end to the firefighting drone 1104, and at a distal end to the square frame 1102. Different strut configurations are possible. For example, in the implementation shown in FIG. 11, a four-strut arrangement is employed. In this arrangement, a strut 1106 extends to the firefighting drone 1104 from the corners of the square frame 1102. Other strut arrangements are also possible using less struts (e.g., 2-3 struts) or more than four struts. In any case, the number or struts and their arrangement should be chosen such that they do not interfere with the rotors of the firefighting drone.

In one implementation, a protective mesh is attached to the frame. This protective mesh acts to protect the rotors of the drone from objects (e.g., tree branches, etc.) that could otherwise come into contact with and damage the rotors. In addition, the protective mesh acts to protect objects or people from the spinning rotors of the drone. FIG. 12 illustrates a firefighting drone unit 1200 with a square frame 1202 and with a protective mech panel 1204 installed over the top of the frame.

In one implementation, the above-described frames, struts and protective mesh are constructed from a strong, lightweight, resilient plastic material such as polycarbonate. This minimizes the weight that the frame adds to the overall firefighting drone unit.

### 1.5.1.1 Interconnection Hardware

The aforementioned frames have several uses. For example, it is employed to connect firefighting drones together via the aforementioned interconnection hardware. In one version, the interconnection hardware takes the form of a semi-permanent connection such as a bolt. In this version, a pair of firefighting drones is connected by bolting a side of the frame of one unit to a side of the frame of another unit. In another version, the interconnection hardware takes the form of quick-release latches. In this version, a pair of firefighting drones is connected by latching a side of the frame of one firefighting drone to a side of the frame of another firefighting drone using the quick-release latches. In yet another version, the quick-release latches are automated in that each can be latched and unlatched via a remotely controlled mechanism. In this version, a pair of firefighting drones are connected by latching a side of the frame of one firefighting drone to a side of the frame of another firefighting drone using the automated quick-release latches. This process can be done during flight by remotely controlling firefighting drones to come together such that the frame sides to be connected are aligned. In this way, the firefighting drones that will make up the interconnected matrix can be connected together before they connect to the evacuation unit. The automated latches are then engaged to connect the drone units together. It is noted that the quick-release latches can be any appropriate mechanical, or magnetic, or electro-magnetic devices that are capable of securing the frame of one drone unit to the frame of another.

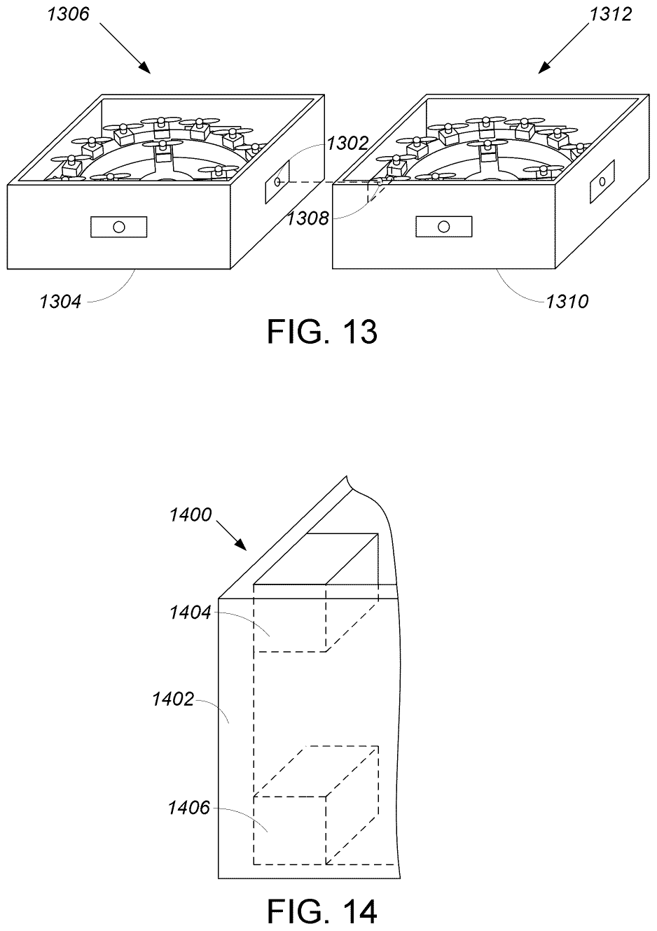

In general, an interconnection hardware assembly can be attached to any structural component of a firefighting drone's frame such that it faces and connects with a structural component of a side of the frame of another firefighting drone. Additionally, in any of the foregoing versions, there can be more than one of the interconnection hardware assemblies attached to a frame side. Referring to FIG. 13, in one implementation, each interconnection hardware assembly 1302 attached to the frame 1304 of a firefighting drone unit 1306 is capable of interfacing with an interconnection hardware assembly 1308 attached to the frame 1310 of another firefighting drone unit 1312.

Connecting multiple drone units together has many advantages owing to the increased carrying capacity of the matrix, as well as longer operating times afforded in one implementation by the additional batteries attached to the frame (see FIG. 14). For example, if it is assumed that a firefighting drone outfitted with one of the above-described frames can lift and carry 400 pounds-then a single-layered matrix of 4 drone units (e.g., configured in a 2×2 matrix) could collectively carry 1600 pounds.

The firefighting drone matrices described above are controlled using existing control equipment and software onboard the individual drones to implement the interconnecting drone scheme. In particular, when more than one drone receives an evacuation command and confirms the evacuation command was transmitted by an authorized person, and the evacuation command specified that two or more of the drones are to interlock and jointly attach to the evacuation unit using the attachment apparatus, the affected firefighting drones interlock into a prescribed-shaped matrix as described previously. The system described herein employs existing equipment and software that is more typically employed to simultaneously control swarms of drones in coordinated flight. It is noted that this existing technology can be remotely controlled by a user, or the drone unit matrix could be autonomous using preloaded instructions.

It is noted that when the desired evacuation task is completed, the firefighting drone matrix can be broken up by releasing the automated quick-release latches and the firefighting drones can again fly separately back to the structure to continue their firefighting duties.

The foregoing description of the interconnected firefighting drone system describes the use of square frames. However, it is not intended to limit the system to these frame shapes. Rather, any practical frame 3D shapes could be employed. For example, a 3D pyramidal, cubic, prism, sphere and so on shape could be used. In addition, while the interconnected drone system was described as forming a firefighting drone matrix from the firefighting drones having the same frame shape, the system is not limited to this arrangement. Rather, firefighting drones having different shapes can be used to form the matrix as well.

In addition to the previously described onboard equipment attached to the frame (batteries, electronics package, and so on) and any equipment that is part of the firefighting drones, addition apparatuses can be added to the drone or matrix of drones using appropriate attachment structures that are connected to the frames or the drones themselves. For example, various structures like a platform onto which items can be placed and secured, or a grabbing apparatus for attaching the firefighting drone or drone matrix to items that are to be lifted and carried, and so on, can be hung below the matrix. Another option is to attach a platform above the drone unit matrix at a height that will not interfere with the aerodynamic performance of the drone rotors.

### 1.6 Additional Implementations

If a wildfire sweeps through an area that has been evacuated and the structure is not burned, either because the fire did not reach the structure or the drone-based fire protection and suppression system was successful in saving the structure from the fire, the structure can be vulnerable to looting as the residents are not yet allowed back into the evacuation zone. In such a situation, the firefighting drones of the fire protection and suppression system can be employed as a security system. This security implementation involves using the camera(s) and other sensors (or the firefighting drone or its docking station) which in this implementation include motion sensors to perform surveillance of the structure and its surrounding area, lights to illuminate the structure and surrounding area at night, a loudspeaker for communicating with people detected during surveillance, and an audible alarm (which employs the loudspeaker in one version). If a person is detected, an alarm can be sent to the owner or the owner's representative via the firefighting drones communication system. If the person detected is someone who is authorized to be at the structure (e.g., a firefighter or other public official or the press), then the alarm can be disregarded. However, if the person detected is not authorized to be in the evacuation zone, the appropriate authorities can be notified. Any currently available security software can be employed by the firefighting drone's computing device to perform the foregoing task, such as the software employed by conventional home security systems. It is noted that one version of the firefighting drone-based security implementation includes the previously described solar/wind battery charging system to provide power to the firefighting drone in case the power to the structure has been shut down or is otherwise unavailable. Further, the security implementation of the drone-based fire prevention, suppression and evacuation system can be employed as a home security system even in the absence of a fire emergency and evacuation.

In the fire emergency and emergency evacuation modes, battery power is a principal consideration as the firefighting drones will be without power from the structure once the electric cable is detached. The ability of some implementations of the drone-based fire prevention, suppression and evacuation system to switch out depleted batteries for charged batteries attests to this battery consideration. However, further measures can be taken to ensure there is adequate battery power to complete the foregoing tasks. In one implementation of the drone-based fire prevention, suppression and evacuation system, an addition docking station is provided that is dedicated to replacing depleted firefighting drone batteries with fully charged batteries. All the firefighting drones being employed have access to this battery changing docking station. Thus, while the regular firefighting docking stations may be limited in the number of battery swaps that can be made (e.g., one set of replacement batteries), the inclusion of the battery changing docking station advantageously increases the time the firefighting drone(s) can be in free flight mode. Further, for implementations with firefighting drones that can interconnect, additional batteries can be added to the previously described frames. For example, referring now to FIG. 14, in one implementation, at least one structural component 1402 of a firefighting drone's frame 1400 includes one or more battery packs 1404 and optionally an electronics package 1406. The battery pack or packs and electronics package are attached to the inside of the frame's structural component so as to not interfere with the attachment of one firefighting drone to another. The battery pack or battery packs are electrically connected to the firefighting drone and can supplement the existing batteries of the drone. This allows the firefighting drone to fly for a longer period of time despite the added weight of the frame and other components attached to the frame. The electronics package (when included) can be used to supplement the existing electronic components of the firefighting drone and/or to add electronic components not included in the drone. For example, the electronics package can include electronic devices such as one or more cameras, microphones, speakers, lights, as well as various sensors (e.g., proximity sensors, GPS unit), battery power status monitor, and so on. Further, if the firefighting drone itself does not include a computing device and software for controlling the drone's operations, or a transceiver for communicating with a remote controller and locally with the other drone units, the electronics package can include the missing computing and communication components.

While the description of the drone-based fire prevention, suppression and evacuation system has to this point focused on spraying water on the structure and optionally its surrounding area, the system is not limited to just water. In one implementation instead of spraying water, one or more of the firefighting drones is configured to spray a fire-retardant material. This can be accomplished by including a storage tank of the fire-retardant material that the water hose of the firefighting drone attaches to rather that the structure's pressurized water supply. The fire-retardant material storage tank includes a pump to feed pressurized fire-retardant material to the firefighting drone. The fire-retardant material storage tank would be housed in the structure being protected or outside the structure adjacent to the firefighting drone's docking station. Additionally, or in lieu of the fire-retardant material storage tank, in one implementation of the water tank installation apparatus, the previously described water tank would be replaced with a similar tank filled with fire-retardant material for use in the fire emergency and emergency evacuation modes where the hose supplying fire-retardant material to the firefighting drone is disconnected. Having both the fire-retardant material storage tank that feeds the hose supplying fire-retardant material to the firefighting drone and an attachable tank filled with fire-retardant material instead of water advantageously allow the firefighting drone to continue to spray fire-retardant material even when the feeder hose is detached. Having just the attachable tank filled with fire-retardant material would allow the firefighting drone to spray water as described previously when the water hose is attached and then spray fire-retardant material when the water hose is detached.

It is further noted that while the drone-based fire prevention, suppression and evacuation system can be owed by the owner of the structure being protected, in one implementation the system is owned by a service company that provides the equipment and charges a rental service fee for its use. This service company could also be responsible for maintaining and operating the system equipment as part of the service agreement.

While the foregoing description of the drone-based fire prevention, suppression and evacuation system describes the use of multi-rotor, battery-operated drones, it is not intended to limit the system to just these drones. Other types of drones can be employed as well. For example, single rotor internal combustion or jet engine driven drones could be used. Hybrid drones could also be employed. Hybrid drones employ both batteries, as well as an internal combustion engine or jet engine to power one or more rotors. Further, vertical takeoff and landing (VTOL) drones which can rotate their rotors from a horizontal orientation for takeoff, landing, hovering, etc. to a vertical orientation for high-speed forward flight could be employed.

While the drone-based fire prevention, suppression and evacuation system implementations described up to this point focused on protecting a structure and optionally the immediate area around the structure, this scope can be expanded. For example, when the system is in free flight mode during a fire emergency, the firefighting drones can be tasked to spray water on structures and areas in the immediate neighborhood of the primary structure being protected. In this way, adjacent structures can be saved and the risk of a fire spreading to the primary structure being protected is reduced. As such, in one implementation, the area around the structure is protected and includes the immediate neighborhood of the primary structure being protected. Further, the drone-based fire prevention, suppression and evacuation system in its emergency evacuation mode can be used to rescue people from dangerous situations, like flood waters, or a forest fire, or a fire in a high-rise building, or any remote location that is inaccessible by typical rescue vehicles.

1. A drone-based fire prevention, suppression and evacuation system, comprising:
a plurality of electric powered firefighting drones dispersed about a structure, each drone comprising one or more nozzles for spraying a portion of the structure that the drone is responsible for spraying with a fire suppressing substance;
a plurality of supply hoses for supplying the fire suppressing substance to the plurality of drones, each supply hose being releasably connected at one end to a different one of the firefighting drones and at the other end to a source of the fire suppressing substance, each supply hose further being long enough for the firefighting drone to which the supply hose is connected to fly about the structure and spray the fire suppressing substance onto the portion of the structure that the drone is responsible for spraying; and
a plurality of electric power cables for supplying electrical power to the plurality of drones, each power cable being releasably connected at one end to a different one of the firefighting drones and at the other end to a source of electrical power, each power cable further being long enough for the firefighting drone to which the power cable is connected to fly about the structure and spray the fire suppressing substance onto the portion of the structure that the drone is responsible for spraying.

2. The drone-based fire prevention, suppression and evacuation system of claim 1, wherein the fire suppressing substance is water and wherein the source of the water is the structure's pressurized water system.

3. The drone-based fire prevention, suppression and evacuation system of claim 1, wherein the source of electrical power is the structure's electric power system.

4. The drone-based fire prevention, suppression and evacuation system of claim 1, wherein one or more of the firefighting drones is additionally responsible for spraying a defined portion of the area surrounding the structure with the fire suppressing substance.

5. The drone-based fire prevention, suppression and evacuation system of claim 1, wherein each of the firefighting drones comprises one or more cameras, a two-way communication system, and a computing device that receives inputs from and controls the firefighting drone including the camera or cameras and the communication system.

6. The drone-based fire prevention, suppression and evacuation system of claim 5, wherein each firefighting drone computing device monitors weather and fire alerts via the drone's communication system to identify conditions indicative of a fire risk to the structure, and whenever a fire risk to the structure is identified, the firefighting drone's computing device controls the firefighting drone to implement a fire prevention action plan that involves the drone periodically flying to positions adjacent the structure and spraying the fire suppressing substance onto a portion of the exterior of the structure.

7. The drone-based fire prevention, suppression and evacuation system of claim 6, wherein the firefighting drones are in communication with each other, and wherein the fire prevention action plan is a joint fire prevention action plan shared by the drones which ensures the fire suppressing substance is sprayed onto the entirety of the exterior of the structure by the collective actions of the drones.

8. The drone-based fire prevention, suppression and evacuation system of claim 5, wherein each of the cameras comprises both visual frequency and infrared frequency imaging capability, and wherein each firefighting drone computing device monitors weather and fire alerts via the drone's communication system and the output from each of the firefighting drones' cameras to identify an active fire that threatens the structure, and whenever an active fire that threatens the structure is identified, the firefighting drone's computing device controls the firefighting drone to implement a fire suppression action plan that involves the drone flying to positions adjacent the structure and continuously spraying the fire suppressing substance onto a portion of the exterior of the structure.

9. The drone-based fire prevention, suppression and evacuation system of claim 8, wherein the firefighting drones are in communication with each other, and wherein the fire suppression action plan is a joint fire suppression action plan shared by the drones which ensures the fire suppressing substance is continuously sprayed onto the entirety of the exterior of the structure by the collective actions of the drones, and whenever one of the firefighting drones implements the joint fire suppression action plan, all the drones implement the joint fire suppression action plan.

10. The drone-based fire prevention, suppression and evacuation system of claim 9, wherein whenever the output from one or more of the firefighting drones' cameras indicates that a portion of the structure or the area immediately surrounding the structure is on fire, one or more of the firefighting drones close enough to spray the fire are directed to spray the fire suppressing substance onto the fire until it is extinguished.

11. The drone-based fire prevention, suppression and evacuation system of claim 8, wherein a fire emergency mode is initiated by one or more of the firefighting drones in circumstances comprising, for each drone:
the electrical power is not available from the electric power cable during a time the drone is executing the fire suppression action plan; or
the fire suppressing substance cannot be obtained from the fire suppressing substance source during a time the drone is executing the fire suppression action plan; or
the output from one or more of the firefighting drones' cameras indicates that a portion of the structure or the area immediately surrounding the structure is on fire and the firefighting drones close enough to spray the fire are unable to extinguish the fire with their fire suppressing substance spray.

12. The drone-based fire prevention, suppression and evacuation system of claim 11, wherein each firefighting drone further comprises batteries for powering the drone whenever the drone is in fire emergency mode, and wherein whenever a firefighting drone is in the fire emergency mode, the drone's computing device causes actions comprising:
a disconnect device disconnecting the water supply hose and electric cable from the drone;
the drone flying to a location having an attachable tank filled with the fire suppressing substance and picking up the tank via an attachment apparatus that attaches the tank to the drone and connects the drone to a fire suppressing substance output of the tank, said tank comprising an electric powered pump that receives electrical power from the drone via an electrical connector on the attachment apparatus and whenever activated pumps fire suppressing substance to the drone's nozzle or nozzles; and
the firefighting drone flying to positions adjacent the structure and continuously spraying the fire suppressing substance onto a prescribed portion of the exterior of the structure, or a portion of the structure or the area immediately surrounding the structure that is on fire, using battery power.

13. The drone-based fire prevention, suppression and evacuation system of claim 12, wherein the attachable tank further comprises a refill tube that hangs down from the tank and is attached to the pump, and wherein whenever the tank needs to be refilled, the firefighting drone's computing device causes the drone to lower the refill tube into an open water source and causes the pump to draw water from the source into the tank.

14. The drone-based fire prevention, suppression and evacuation system of claim 12, wherein each firefighting drone's batteries for powering the drone whenever the drone is in fire emergency mode are replaceable batteries, and wherein whenever a firefighting drone is in the fire emergency mode and the batteries require replacement, the drone's computing device causes actions comprising:
the firefighting drone flying to a location having fully charged replacement batteries and a battery replacement apparatus for replacing the batteries powering the drone with the fully charged replacement batteries; and
replacing the batteries powering the drone with the fully charged replacement batteries via the battery replacement apparatus.

15. The drone-based fire prevention, suppression and evacuation system of claim 11, wherein each firefighting drone further comprises batteries for powering the drone whenever the drone is in fire emergency mode, and wherein whenever a firefighting drone is in the fire emergency mode, the drone's computing device causes actions comprising:
a disconnect device disconnecting the water supply hose and electric cable from the drone;
the firefighting drone flying to a location having an attachable tank filled with the fire suppressing substance and picking up the tank via an attachment apparatus that attaches the tank to the drone, said attachable tank comprising a plurality of openable and closeable ports; and
the firefighting drone flying to the structure, then opening the tank ports and then pouring the fire suppressing substance onto a prescribed portion of the exterior of the structure, or a portion of the structure or the area immediately surrounding the structure that is on fire, using battery power.

16. The drone-based fire prevention, suppression and evacuation system of claim 15, wherein whenever the attachable tank needs to be refilled, the firefighting drone's computing device causes actions comprising:
the firefighting drone flying to an open water source, then opening the tank ports, then lowering the tank into the open water source, and then once the tank is full of water, closing the tank ports; and
the firefighting drone flying to the structure, then opening the tank ports and then pouring the water onto a prescribed portion of the exterior of the structure, or a portion of the structure or the area immediately surrounding the structure that is on fire.

17. The drone-based fire prevention, suppression and evacuation system of claim 15, wherein each firefighting drone's batteries for powering the drone whenever the drone is in fire emergency mode are replaceable batteries, and wherein whenever a firefighting drone is in the fire emergency mode and the batteries require replacement, the drone's computing device causes actions comprising:
the firefighting drone flying to a location having fully charged replacement batteries and a battery replacement apparatus for replacing the batteries powering the drone with the fully charged replacement batteries; and
replacing the batteries powering the drone with the fully charged replacement batteries via the battery replacement apparatus.

18. A drone-based evacuation system, comprising:
a plurality of electric powered drones, each comprising batteries for powering the drone, one or more cameras, a GPS system, a two-way communication system, and a computing device that receives inputs from and controls the drone including the camera or cameras, GPS system and the communication system;
an evacuation unit comprising a structure with securing devices for securing one or more persons, or cargo, or both in the evacuation unit; and
an attachment apparatus that automatically attaches one or more of the drones to an evacuation unit; and wherein,
whenever one of the drone's computing device receives an evacuation command, the drone's computing device causes actions comprising,
confirming the evacuation command was transmitted by a person authorized to order the drone to evacuate one or more persons, or cargo, or both in the evacuation unit,
whenever it is confirmed that the evacuation command was transmitted by an authorized person,
flying the drone to a prescribed storage area where the evacuation unit is located,
attaching the evacuation unit to the drone using the attachment apparatus,
flying the drone with the evacuation unit attached to a prescribed evacuation site for loading of one or more people, or cargo, or both into the evacuation unit if the evacuation site is not at the storage area, and
after the loading of one or more persons, or cargo, or both into the evacuation unit is complete, flying the drone with the loaded evacuation unit attached to prescribed safe location.

19. The drone-based evacuation system of claim 18, wherein each drone resides within and is attached to a drone frame that surrounds the drone, and wherein the drone frame comprises interlocking mechanisms that attach the frame of one drone to one or more other drone frames to form a two-dimensional drone matrix, and wherein interlocked drones are in communication with each other and fly as a single unit, and wherein more than one drone receives an evacuation command and confirms the evacuation command was transmitted by an authorized person, and wherein the evacuation command specified that two or more of the drones are to interlock and jointly attach to the evacuation unit using the attachment apparatus.

20. A drone-based fire prevention, suppression and evacuation system, comprising:
a plurality of electric powered firefighting drones dispersed about a structure, each drone comprising one or more nozzles for spraying a portion of the structure that the drone is responsible for spraying with a fire suppressing substance;
a plurality of supply hoses for supplying the fire suppressing substance to the plurality of drones, each supply hose being releasably connected at one end to a different one of the firefighting drones and at the other end to a source of the fire suppressing substance, each supply hose further being long enough for the firefighting drone to which the supply hose is connected to fly about the structure and spray the fire suppressing substance onto the portion of the structure that the drone is responsible for spraying;
a plurality of electric power cables for supplying electrical power to the plurality of drones, each power cable being releasably connected at one end to a different one of the firefighting drones and at the other end to a source of electrical power, each power cable further being long enough for the firefighting drone to which the power cable is connected to fly about the structure and spray the fire suppressing substance onto the portion of the structure that the drone is responsible for spraying: and
a plurality of docking stations each of which is employed to house and protect a different one of the firefighting drones whenever the drone is not in use.
